(19) United States
(12) Patent Application Publication
(10) Pub. No.: US 2021/0309863 A1
(43) Pub. Date: Oct. 7, 2021

(54) ANTI-REFLECTIVE FILM, POLARIZING PLATE, AND DISPLAY APPARATUS

(71) Applicant: LG CHEM, LTD., Seoul (KR)

(72) Inventors: Jinseok BYUN, Daejeon (KR); So Young KIM, Daejeon (KR); Kyung Moon KO, Daejeon (KR); Sang Heon LEE, Daejeon (KR); Intaek SONG, Daejeon (KR); Yeongrae CHANG, Daejeon (KR)

(73) Assignee: LG CHEM, LTD., Seoul (KR)

(21) Appl. No.: 17/270,191

(22) PCT Filed: May 28, 2020
(86) PCT No.: PCT/KR2020/006893

§ 371 Date: Feb. 22, 2021

(30) Foreign Application Priority Data
May 28, 2019 (KR) 10-2019-0062632
May 27, 2020 (KR) 10-2020-0063618

(51) Int. Cl. C09D 5/00; C09D 135/02; C09D 7/61; C09D 7/40; G02B 1/14; G02B 1/111

(52) U.S. Cl. CPC C09D 5/006; C09D 5/002; C09D 135/02; C09D 7/61; G02B 5/3025; C09D 7/68; C09D 7/70; G02B 1/14; G02B 1/111; C09D 7/67

(57) ABSTRACT

The invention relates to an anti-reflective film that has low reflectance deviation and light transmittance deviation, can simultaneously realize high scratch resistance and anti-fouling property, and can increase screen sharpness of a display apparatus, a polarizing plate and a display apparatus comprising the same.

This application is a 35 U.S.C. 371 National Phase Entry Application from PCT/KR2020/006893, filed on May 28, 2020, designating the United States, which claims the benefit of Korean Patent Application No. 10-2019-0062632 filed on May 28, 2019, and Korean Patent Application No. 10-2020-0063618 filed on May 27, 2020 with the Korean Intellectual Property Office, the disclosures of which are herein incorporated by reference in their entirety.

### BACKGROUND OF THE INVENTION

### (a) Field of the Invention

The invention relates to an anti-reflective film, a polarizing plate, and a display apparatus.

### (b) Background of the Invention

In general, in flat panel display devices such as PDP, LCD, etc., an anti-reflective film is installed so as to minimize the reflection of incident light from the outside. Methods for minimizing the reflection of light include a method of dispersing filler such as inorganic fine particles, etc. in resin, coating it on a substrate film, and forming unevenness (anti-glare: AG coating); a method of using light interference by forming plural layers having different refractive indexes on a substrate film (anti-reflection; AR coating), or a method of using them together, etc.

Among them, in the case of AG coating, although the absolute amount of reflected light is equivalent to common hard coatings, low reflection effect can be obtained by reducing the amount of light entering the eyes using light scattering through unevenness. However, since the AG coating has lowered screen sharpness due to the surface unevenness, recently, many studies are being progressed on AR coating.

As a film using the AR coating, those having a multi-layered structure in which a hard coating layer (high refractive index layer), low reflective index coating layer, etc. are stacked on a light transmitting substrate film are being commercialized. However, since the method of forming plural layers separately conducts the processes of forming each layer, it has a disadvantage in that scratch resistance is lowered due to weak interlayer adhesion (interface adhesion). Thus, previously, in order to improve scratch resistance of the low refractive index layer included in the anti-reflective film, a method of adding various particles of nanometer size (for example, silica, alumina, zeolite, etc.) was mainly attempted. However, in case nanometer-sized particles are used, it was difficult to simultaneously increase scratch resistance while lowering the reflectance of the low refractive layer, and due to the nanometer-sized particles, the anti-fouling property of the surface of the low refractive index layer was significantly deteriorated.

Meanwhile, a light transmitting substrate film known to be commonly used in an anti-reflective film has a limitation of large optical property deviation.

### BRIEF SUMMARY OF THE INVENTION

It is an object of the invention to provide an anti-reflective film that has low reflectance deviation and light transmittance deviation, can simultaneously realize high scratch resistance and anti-fouling property, and can increase screen sharpness of a display apparatus.

It is another object of the invention to provide a polarizing plate comprising the above anti-reflective film.

It is another object of the invention to provide a display apparatus that comprises the above anti-reflective film and provides high screen sharpness.

There is provided an anti-reflective film comprising a light transmitting substrate; a hard coating layer; and a low refractive index layer, wherein a first peak appears at 2θ value of 25 to 27°, and a second peak appears at 2θ value of 46 to 48°, in X-ray diffraction (XRD) pattern of reflection mode, and a rate (P2/P1) of the intensity of the second peak (P2) to the intensity of the first peak (P1) is 0.01 or more.

There is also provided a polarizing plate comprising the anti-reflective film.

There is also provided a display apparatus comprising the anti-reflective film.

Hereinafter, an anti-reflective film, a polarizing plate and a display apparatus according to specific embodiments of the invention will be explained in more detail.

As used herein, the terms ‘first’ and ‘second’ are used to explain various constructional elements, and the terms are used only to distinguish one constructional element from the other constructional element.

And, a low refractive index layer may mean a layer having low refractive index, for example, a layer having refractive index of about 1.2 to 1.8 at the wavelength of 550 nm.

And, for specific measured quantities x and y, when the x value is changed and the y value is recorded according to the x value, if the maximum value (or extreme value) of the y appears, a peak means that part. Wherein, the maximum value means the largest value in the peripheral part, and the extreme value means a value where instantaneous rate of change is 0.

And, hollow inorganic particles mean particles wherein an empty space exists on the surface and/or inside of the inorganic particles.

And, (meth)acryl includes both acryl and methacryl.

And, (co)polymer includes both copolymer and homopolymer.

And, a fluorine-containing compound means a compound comprising at least one fluorine atom in the compound.

And, a photopolymerizable compound commonly designates a polymer compound that is polymerized by the irradiation of light, for example, by the irradiation of visible rays or ultraviolet rays.

According to one embodiment of the invention, there is provided an anti-reflective film comprising a light transmitting substrate; a hard coating layer; and a low refractive index layer, wherein a first peak appears at 2θ value of 25 to 27°, and a second peak appears at 2θ value of 46 to 48°, in X-ray diffraction (XRD) pattern of reflection mode, and a rate (P2/P1) of the intensity of the second peak (P2) to the intensity of the first peak (P1) is 0.01 or more.

The inventors progressed studies on an anti-reflective film, confirmed through experiments that an anti-reflective film wherein a first peak appears at 2θ value of 25 to 27° and a second peak appears at 2θ value of 46 to 48°, in X-ray diffraction (XRD) pattern of reflection mode, and a rate (P2/P1) of the intensity of the second peak (P2) to the intensity of the first peak (P1) is 0.01 or more, exhibits similar reflectance and light transmittance across the whole anti-reflective film, and thus, has small reflectance deviation and light transmittance deviation, can simultaneously realize high scratch resistance and anti-fouling property, and has screen sharpness of a display apparatus, and completed the invention.

The anti-reflective film has small reflectance deviation and light transmittance deviation across the whole film, and thus, can increase screen sharpness of a display apparatus, and has excellent scratch resistance and high anti-fouling property, and thus, can be easily applied for the manufacturing process of a display apparatus or a polarizing plate, and the like, without specific limitations.

Specifically, the X-ray diffraction pattern can be calculated using a reflection mode, among X-ray irradiation modes.

In the X-ray diffraction (XRD) pattern of reflection mode obtained from the anti-reflective film according to one embodiment, two or more peaks may appear. Specifically, one peak appears at 2θ of 25 to 27°, which is defined as a first peak, and one peak appears at 2θ of 46 to 48°, which is defined as a second peak.

Thus, a first peak appears at 2θ value of 25 to 27°, and a second peak appears at 2θ value of 46 to 48°. And, a rate (P2/P1) of the intensity of the second peak (P2) to the intensity of the first peak (P1) is 0.01 or more, 0.015 or more, 0.02 to 0.1, or 0.03 to 0.09. Thereby, similar reflectance and light transmittance may be exhibited across the whole anti-reflective film, thus realizing an anti-reflective film having low reflectance deviation and light transmittance deviation, and having improved scratch resistance or anti-fouling property.

Since each one peak appears at 2θ value of 25 to 27° and at 2θ value of 46 to 48° in X-ray diffraction (XRD) pattern of reflection mode, and a rate (P2/P1) of the intensity of the second peak (P2) to the intensity of the first peak (P1) is 0.01 or more, each crystal face (100) and (−210) in the light transmitting substrate is evenly arranged, and thus, the anti-reflective film comprising the light transmitting substrate may have small reflectance deviation.

If a peak does not appear at 2θ value of 25 to 27° or a peak does not appear at 2θ value of 46 to 48° in X-ray diffraction pattern of reflection mode, (100) or (−210) crystal face may not be properly formed in the light transmitting substrate.

And, if the rate (P2/P1) of the intensity of the second peak (P2) to the intensity of the first peak (P1) is less than 0.01, reflectance deviation of the anti-reflective film may be large, and thus, visibility may be lowered.

Meanwhile, the incident angle (θ) means an angle made by a crystal plane and X-ray, when X-ray is irradiated to a specific crystal plane, and the diffraction peak means a point where the first derivative (gradient of tangent line, dy/dx) is 0, where the first derivative (gradient of tangent line, dy/dx) of the y-axis of diffraction intensity to the x-axis of 2θ value changes from positive to negative, as the x-axis of 2 times (2θ) of the incident angle of entering X-ray increases in a positive direction, in a graph wherein the x-axis of the x-y plane is 2 times (2θ) of the incident angle of entering X-ray, and the y-axis of x-y plane is diffraction intensity.

The 2θ values of the first peak and the second peak may result from specific d-spacing in the polymer crystal in the light transmitting substrate, and the rate of the intensity of the second peak (P2) to the intensity of the first peak (P1) may result from the size of polymer crystal in the light transmitting substrate.

Specifically, specific d-spacing in the light transmitting substrate may be confirmed from the 2θ value of the peak appearing in the XRD pattern of reflection mode. More specifically, at Cu target and wavelength (λ) of 1.54 Å, the (−210) crystal face in the light transmitting substrate may appear as the second peak at 2θ of 46 to 48°, and the (100) crystal face in the light transmitting substrate may appear as the first peak at 2θ of 25 to 27°.

And, the size of the polymer crystal in the light transmitting substrate may appear as the rate (P2/P1) of the strength of the second peak (P2) to the strength of the first peak (P1), and as the strength ratio (P2/P1) is higher, the size of the polymer crystals in the light transmitting substrate increases, and thus, the polymer crystals may be arranged with high alignment degree in the light transmitting substrate.

The low refractive index layer included in the anti-reflective film according to one embodiment may comprise binder resin, and inorganic nanoparticles dispersed in the binder resin.

Meanwhile, the binder resin may comprise (co)polymer of photopolymerizable compounds. The photopolymerizable compound forming the binder resin may include monomers or oligomers comprising vinyl groups or (meth)acrylate. Specifically, the photopolymerizable compound may include monomers or oligomers comprising 1 or more, or 2 or more, or 3 or more vinyl groups or (meth)acrylate.

As specific examples of the monomers or oligomers comprising (meth)acrylate, pentaerythritol tri(meth)acrylate, pentaerythritol tetra(meth)acrylate, dipentaerythritol penta(meth)acrylate, dipentaerythritol hexa(meth)acrylate, tripentaerythritol hepta(meth)acrylate, trilene diisocyanate, xylene diisocyanate, hexamethylene diisocyanate, trimethylol propane tri(meth)acrylate, trimethylolpropane polyethoxy tri(meth)acrylate, trimethylolpropane trimethacrylate, ethyleneglycol dimethacrylate, butanediol dimethacrylate, hexaethyl methacrylate, butyl methacrylate or mixtures of two or more kinds thereof, or urethane modified acrylate oligomer, epoxide acrylate oligomer, ether acrylate oligomer, dendritic acrylate oligomer, or mixtures of two or more kinds thereof may be mentioned. Wherein, the molecular weight of the oligomer may be 1,000 to 10,000.

As specific examples of the monomers or oligomers comprising vinyl groups, divinyl benzene, styrene or paramethyl styrene may be mentioned.

Although the content of a part derived from the photopolymerizable compounds in the binder resin is not significantly limited, considering the mechanical properties of the finally prepared low refractive index layer or anti-reflective film, the content of the photopolymerizable compounds may be 10 wt % to 80 wt %, 15 to 70 wt %, 20 to 60 wt %, or 30 to 50 wt %. If the content of the photopolymerizable compounds is less than 10 wt %, scratch resistance or anti-fouling property of the low refractive index layer may be significantly deteriorated, and if it exceeds 80 wt %, reflectance may increase.

Meanwhile, the binder resin may further comprise crosslinked polymer of a photopolymerizable compound, and a fluorine-containing compound comprising a photoreactive functional group.

Due to the properties of the fluorine atom included in the fluorine-containing compound comprising a photoreactive functional group, the interaction energy of the anti-reflective film with liquids or organic substances may be lowered, and thus, the amount of pollutants transferred to the anti-reflective film may be reduced, transferred pollutants may be prevented from remaining on the surface, and pollutants themselves may be easily removed.

And, in the process of forming the low refractive index layer and anti-reflective film, the reactive functional group included in the fluorine-containing compound comprising a photoreactive functional group may act as crosslink, thereby increasing physical durability, scratch resistance and thermal stability of the low refractive index layer and anti-reflective film.

In the fluorine-containing compound comprising a photoreactive functional group, one or more photoreactive functional groups may be included or substituted, and the photoreactive functional group means a functional group capable of participating in a polymerization reaction by the irradiation of light, for example, by the irradiation of visible rays or ultraviolet rays. The photoreactive functional group may include various functional groups capable of participating in a polymerization reaction by the irradiation of light, and specific examples thereof may include a (meth)acrylate group, an epoxide group, a vinyl group or a thiol group.

The fluorine-containing compound comprising a photoreactive functional group may have weight average molecular weight (weight average molecular weight converted in terms of polystyrene, measured by GPC) of 2,000 to 200,000, preferably 5,000 to 100,000.

If the weight average molecular weight of the fluorine-containing compound comprising a photoreactive functional group is too small, the fluorine-containing compounds may not be uniformly and effectively arranged on the surface of the low refractive index layer but be positioned inside, and thus, the anti-fouling property of the surface of the low refractive index layer and anti-reflective film may be deteriorated, and the crosslinking density inside of the low refractive index layer and anti-reflective film may be lowered, and thus, mechanical properties such as overall strength or scratch resistance, and the like may be deteriorated. And, if the weight average molecular weight of the fluorine-containing compound comprising a photoreactive functional group is too high, haze of the low refractive index layer and anti-reflective film may increase, or light transmittance may decrease, and the strength of the low refractive index layer and anti-reflective film may be also deteriorated.

Specifically, the fluorine-containing compound comprising a photoreactive functional group may be one or more selected from the group consisting of i) aliphatic compounds or alicyclic compounds substituted with one or more photoreactive functional groups, in which at least one carbon is substituted with one or more fluorine atoms; ii) heteroaliphatic compounds or heteroalicyclic compounds substituted with one or more photoreactive functional groups, in which at least one hydrogen is substituted with fluorine, and at least one carbon is substituted with silicon; iii) polydialkyl siloxane-based polymer substituted with one or more photoreactive functional groups, in which at least one silicon is substituted with one or more fluorine atoms (for example, polydimethylsiloxane-based polymer); iv) polyether compounds substituted with one or more photoreactive functional groups, in which at least one hydrogen is substituted with fluorine.

The binder resin included in the low refractive index layer may comprise crosslinked polymer of a photopolymerizable compound and a fluorine-containing compound comprising a photoreactive functional group.

The crosslinked polymer may comprise, based on 100 parts by weight of parts derived from the photopolymerizable compound, 1 to 300 parts by weight, 2 to 250 parts by weight, 3 to 200 parts by weight, 5 to 190 parts by weight, or 10 to 180 parts by weight of parts derived from the fluorine-containing compound comprising a photoreactive functional group. The content of the fluorine-containing compound comprising a photoreactive functional group to the photopolymerizable compound is based on the total content of the fluorine-containing compound comprising a photoreactive functional group. If the fluorine-containing compound comprising a photoreactive functional group is excessively added compared to the photopolymerizable compound, the low refractive index layer may not have sufficient durability or scratch resistance. And, if the content of the fluorine-containing compound comprising a photoreactive functional group compared to on the photopolymerizable compound is too small, the low refractive index layer may not have sufficient mechanical properties such as anti-fouling property or scratch resistance, and the like.

The fluorine-containing compound comprising a photoreactive functional group may further comprise silicon or a silicon compound. Namely, the fluorine-containing compound comprising a photoreactive functional group may optionally contain silicon or a silicon compound inside, and specifically, the content of silicon in the fluorine-containing compound comprising a photoreactive functional group may be 0.1 to 20 wt %.

The content of silicon or a silicon compound included in the fluorine-containing compound comprising a photoreactive functional group may be confirmed by a commonly known analysis method, for example, ICP (Inductively Coupled Plasma) analysis.

The silicon included in the fluorine-containing compound comprising a photoreactive functional group may increase compatibility with other components included in the low refractive index layer, thereby preventing generation of haze in the finally prepared low refractive index layer and increasing transparency, and may improve slip property of the surface of the finally prepared low refractive index layer or anti-reflective film to increase scratch resistance.

Meanwhile, if the content of silicon in the fluorine-containing compound comprising a photoreactive functional group becomes too large, the low refractive index layer or anti-reflective film may not have sufficient light transmittance or anti-reflection performance, and anti-fouling property of the surface may be also deteriorated.

And, the binder resin may further comprise a crosslinked polymer between a photopolymerizable compound, a fluorine-containing compound comprising a photoreactive functional group, and polysilsesquioxane substituted with one or more reactive functional groups.

Meanwhile, the polysilsesquioxane substituted with one or more reactive functional groups may increase mechanical properties, for example, scratch resistance of the low refractive index layer due to the reactive functional groups existing on the surface, and contrary to the case of using previously known fine particles such as silica, alumina, zeolite, and the like, it may improve alkali resistance of the low refractive index layer, and improve average reflectance or appearance property such as color, and the like.

The polysilsesquioxane may be written as (RSiO_{1.5})ₙ (wherein, n is 4 to 30 or 8 to 20), and it may have various structures such as a random structure, a ladder type, a cage and a partial cage, and the like. Preferably, in order to increase the properties and quality of the low refractive index layer and anti-reflective film, as the polysilsesquioxane substituted with one or more reactive functional groups, polyhedral oligomeric silsesquioxane of a cage structure substituted with one or more reactive functional groups may be used.

And, more preferably, the polyhedral oligomeric silsesquioxane of a cage structure substituted with one or more reactive functional groups may comprise 8 to 20 silicon atoms in the molecule.

And, at least one of the silicon of the polyhedral oligomeric silsesquioxane of a cage structure may be substituted with a reactive functional group, and the silicon not substituted with a reactive functional group may be substituted with the above-explained non-reactive functional groups.

Since at least one of the silicon atoms of the polyhedral oligomeric silsesquioxane of a cage structure is substituted with a reactive functional group, the mechanical properties of the low refractive index layer and the binder resin may be improved, and since remaining silicon atoms are substituted with non-reactive functional groups, steric hindrance appears to significantly decrease the frequency or probability of siloxane bonds (—Si—O—) being exposed outside, thereby improving alkali resistance of the low refractive index layer and the binder resin.

The reactive functional group substituted at polysilsesquioxane may include one or more functional groups selected from the group consisting of alcohol, amine, carboxylic acid, epoxide, imide, (meth)acrylate, nitrile, norbornene, olefin (allyl, cycloalkenyl or vinyldimethylsilyl, and the like), polyethyleneglycol, thiol and vinyl groups, preferably, epoxide or (meth)acrylate.

As specific examples of the reactive functional groups, (meth)acrylate, C1-20 alkyl (meth)acrylate, C3-20 cycloalkyl epoxide, C1-10 alkyl cycloalkane epoxide may be mentioned. The alkyl (meth)acrylate means that another part of ‘alkyl’ that is not bonded with (meth)acrylate is a bonding position, the cycloalkyl epoxide means that another part of ‘cycloalkyl’ that is not bonded with epoxide is a bonding position, and the alkyl cycloalkane epoxide means that another part of ‘alkyl’ that is not bonded with cycloalkane epoxide is a bonding position.

Meanwhile, the polysilsesquioxane substituted with one or more reactive functional groups may further comprise one or more non-reactive functional groups selected from the group consisting of a C1-20 linear or branched alkyl group, a C6-20 cyclohexyl group and a C6-20 aryl group, in addition to the above explained reactive functional groups. Since reactive functional groups and non-reactive functional groups are substituted on the surface of the polysilsesquioxane, in the polysilsesquioxane substituted with one or more reactive functional groups, siloxane bonds (—Si—O—) may be positioned inside of the molecule without being exposed outside, thereby further increasing alkali resistance and scratch resistance of the low refractive index layer and anti-reflective film.

As examples of the polyhedral oligomeric silsesquioxane (POSS) substituted with one or more reactive functional groups and having a cage structure, POSS substituted with one or more alcohol such as TMP diolIsobutyl POSS, cyclohexanediol isobutyl POSS, 1,2-propanediolIsobutyl POSS, octa(3-hydroxy-3 methylbutyldimethylsiloxy) POSS, and the like; POSS substituted with one or more amine such as aminopropylIsobutyl POSS, aminopropylIsooctyl POSS, aminoethylaminopropyl isobutyl POSS, N-phenylaminopropyl POSS, N-methylaminopropyl isobutyl POSS, octaAmmonium POSS, aminophenyl cyclohexyl POSS, aminophenyl isobutyl POSS, and the like; POSS substituted with one or more carboxylic acid such as maleamic acid-cyclohexyl POSS, maleamic acid-isobutyl POSS, octa maleamic acid POSS, and the like; POSS substituted with one or more epoxide such as epoxy cyclohexyl isobutyl POSS, epoxy cyclohexyl POSS, glycidyl POSS, glycidylethyl POSS, glycidylisobutyl POSS, glycidylisooctyl POSS, and the like; POSS substituted with one or more imide such as POSS maleimide cyclohexyl, POSS maleimide isobutyl, and the like; POSS substituted with one or more (meth)acrylate such as acryloIsobutyl POSS, (meth)acryl isobutyl POSS, (meth)acrylate cyclohexyl POSS, (meth)acrylate isobutyl POSS, (meth)acrylate ethyl POSS, (meth)acryl ethyl POSS, (meth)acrylate isooctyl POSS, (meth)acryl isooctyl POSS, (meth)acryl phenyl POSS, (meth)acryl POSS, acrylo POSS, and the like; POSS substituted with one or more nitrile groups such as cyanopropylIsobutyl POSS, and the like; POSS substituted with one or more norbornene groups such as norbornenyl ethyl ethyl POSS, norbornenyl ethyl isobutyl POSS, norbornenyl ethyl disilanoisobutyl POSS, trisnorbornenyl isobutyl POSS, and the like; POSS substituted with one or more vinyl groups such as allyl isobutyl POSS, monovinylisobutyl POSS, octacyclohexenyldimethylsilyl POSS, octavinyldimethylsilyl POSS, octavinyl POSS, and the like; POSS substituted with one or more olefin such as allylisobutyl POSS, monovinylisobutyl POSS, octacyclohexenyldimethylsilyl POSS, octavinyldimethylsilyl POSS, octavinyl POSS, and the like; POSS substituted with C5-30 PEG; POSS substituted with one or more thiol groups such as mercaptopropylIsobutyl POSS or mercaptopropylIsooctyl POSS, and the like, may be mentioned.

The crosslinked polymer of a photopolymerizable compound, a fluorine-containing compound comprising a photoreactive functional group, and polysilsesquioxane substituted with one or more reactive functional groups may comprise, based on 100 parts by weight of the photopolymerizable compound, 0.5 to 60 parts by weight, 1.5 to 45 parts by weight, 3 to 40 parts by weight, or 5 to 30 parts by weight of the polysilsesquioxane substituted with one or more reactive functional groups.

If the content of parts derived from the polysilsesquioxane substituted with one or more reactive functional groups compared to parts derived from the photopolymerizable compound in the binder resin is too small, it may be difficult to sufficiently secure scratch resistance of the low refractive index layer. And, if the content of parts derived from the polysilsesquioxane substituted with one or more reactive functional groups compared to parts derived from the photopolymerizable compound in the binder resin is too large, transparency of the low refractive index layer or anti-reflective film may be deteriorated, and scratch resistance may be deteriorated to the contrary.

Meanwhile, the low refractive index layer included in the anti-reflective film according to one embodiment may comprise inorganic fine particles dispersed in the binder resin. The inorganic fine particles mean inorganic particles having nanometer or micrometer sized diameters.

Specifically, the inorganic fine particles may include solid inorganic nanoparticles and/or hollow inorganic nanoparticles. The solid inorganic nanoparticles mean particles having a diameter of 100 nm or less, inside of which an empty space does not exist.

And, the hollow inorganic nanoparticles mean particles having a diameter of 200 nm or less, on the surface and/or inside of which an empty space exists.

The solid inorganic nanoparticles may have a diameter of 0.5 to 100 nm, 1 to 80 nm, 2 to 70 nm or 5 to 60 nm.

The hollow inorganic nanoparticles may have a diameter of 1 to 200 nm, 10 to 150 nm, 20 to 130 nm, 30 to 110 nm or 40 to 100 nm.

Meanwhile, each of the solid inorganic nanoparticles and the hollow inorganic nanoparticles may include one or more reactive functional groups selected from the group consisting of a (meth)acrylate group, an epoxide group, a vinyl group and a thiol group on the surface. Since each of the solid inorganic nanoparticles and the hollow inorganic nanoparticles includes the above explained reactive functional groups on the surface, the low refractive index layer may have higher crosslinking density, thereby securing further improved scratch resistance and anti-fouling property.

As the hollow inorganic nanoparticles, nanoparticles coated with a fluorine-containing compound on the surface may be used alone, or in combination with hollow inorganic nanoparticles that are not coated with a fluorine-containing compound on the surface. If the surface of the hollow inorganic nanoparticles is coated with a fluorine-containing compound, surface energy may be further lowered, thereby further increasing durability or scratch resistance of the low refractive index layer.

As a method of coating a fluorine-containing compound on the surface of the hollow inorganic nanoparticles, commonly known particle coating method or polymerization method may be used without specific limitations, and for example, the hollow inorganic nanoparticles and fluorine-containing compound may be subjected to a sol-gel reaction in the presence of water and a catalyst to bind the fluorine-containing compound on the surface of the hollow inorganic nanoparticles through hydrolysis and condensation reaction.

Specific examples of the hollow inorganic nanoparticles may include hollow silica particles. The hollow silica may comprise functional groups substituted on the surface so that it may be more easily dispersed in an organic solvent. Examples of the organic functional groups that can be substituted on the surface of the hollow silica particles are not significantly limited, and for example, a (meth)acrylate group, a vinyl group, a hydroxyl group, an amine group, an allyl group, an epoxy group, an isocyanate group, an amine group, or fluorine, and the like may be substituted on the surface of the hollow silica.

The binder resin of the low refractive index layer may comprise, based on 100 parts by weight of the photopolymerizable compound, 10 to 600 parts by weight of, 20 to 550 parts by weight of, 50 to 500 parts by weight of, 100 to 400 parts by weight of, or 150 to 350 parts by weight of the inorganic fine particles. If the inorganic fine particles are excessively added, due to decrease in the content of binder, scratch resistance or abrasion resistance of the coating film may be deteriorated.

Meanwhile, the low refractive index layer may be obtained by coating a photocurable coating composition comprising a photopolymerizable compound, a fluorine-containing compound comprising a reactive functional group, polysilsesquioxane substituted with one or more reactive functional groups, and the inorganic fine particles on the light transmitting substrate, and photocuring the coated product.

And, the photocurable coating composition may further comprise a photoinitiator. Thus, in the low refractive index layer prepared from the above explained photocurable coating composition, the photopolymerization initiator may remain.

As the photopolymerization initiator, compounds known to be usable in a photocurable resin composition may be used without specific limitations, and specifically, a benzophenon-based compound, an acetophenon-based compound, a biimidazole-based compound, a triazine-based compound, an oxime-based compound or mixtures of two or more thereof may be used.

Based on 100 parts by weight of the photopolymerization compound, the photopolymerization initiator may be used in the content of 1 to 100 parts by weight, 5 to 90 parts by weight, 10 to 80 parts by weight, 20 to 70 parts by weight, or 30 to 60 parts by weight. If the amount of the photopolymerization initiator is too small, materials that are not-cured in the photocuring step and remain may be generated. If the amount of the photopolymerization initiator is too large, non-reacted initiator may remain as impurity or crosslinking density may decrease, and thus, the mechanical properties of the prepared film may be deteriorated or reflectance may be significantly increased.

And, the photocurable coating composition may further comprise an organic solvent. Non-limiting examples of the organic solvent may include ketones, alcohols, acetates and ethers, or mixtures of two or more kinds thereof.

As specific examples of the organic solvent, ketones such as methylethyl ketone, methyl isobutyl ketone, acetylacetone or isobutyl ketone, and the like; alcohols such as methanol, ethanol, n-propanol, i-propanol, n-butanol, i-butanol or t-butanol, and the like; acetates such as ethyl acetate, i-propyl acetate, or polyethyleneglycol monomethylether acetate, and the like; ethers such as tetrahydrofuran or propyleneglycol monomethylether, and the like; mixtures of two or more kinds thereof may be mentioned.

The organic solvent may be added when mixing each component included in the photocurable coating composition, or it may be included in the photocurable coating composition while each component is dispersed or mixed in the organic solvent and added. If the content of the organic solvent in the photocurable coating composition is too small, flowability of the photocurable coating composition may be deteriorated to generate defects such as stripes in the finally prepared film. And, if the organic solvent is excessively added, solid content may decrease, and thus, coating and film formation may not be sufficiently achieved, and the properties or surface properties of the film may be deteriorated, and defects may be generated during drying and curing processes. Thus, the photocurable coating composition may comprise an organic solvent such that the total solid content concentration of the included components may become 1 wt % to 50 wt %, or 2 to 20 wt %.

Meanwhile, for the application of the photocurable coating composition, commonly used methods and apparatuses may be used without specific limitations, and for example, bar coating such as Meyer bar, etc., gravure coating, 2 roll reverse coating, vacuum slot die coating, 2 roll coating, etc. may be used.

In the step of photocuring the photocurable coating composition, UV or visible rays of 200-400 nm wavelength may be irradiated, wherein the exposure amount may be preferably 100 to 4,000 mJ/cm². The exposure time is not specifically limited, and may be appropriately changed according to the exposure apparatus used, the wavelength of irradiated light rays or exposure amount.

And, in the step of photocuring the photocurable coating composition, nitrogen purging, etc. may be conducted so as to apply nitrogen atmosphere condition.

As the hard coating layer included in the hard coating film of one embodiment, commonly known hard coating layers may be used without specific limitations. One example of the hard coating layer may include a hard coating layer comprising binder resin comprising photocurable resin; and organic or inorganic fine particles dispersed in the binder resin.

The photocurable resin included in the hard coating layer may be polymer of photocurable compounds capable of inducing a polymerization reaction if light such as UV, etc. is irradiated, commonly known in the art. Specifically, the photocurable resin may include one or more selected from the group consisting of: reactive acrylate oligomers such as urethane acrylate oligomer, epoxide acrylate oligomer, polyester acrylate, and polyether acrylate; and multifunctional acrylate monomers such as dipentaerythritol hexaacrylate, di pentaerythritol hydroxy pentaacrylate, pentaerythritol tetraacrylate, pentaerythritol triacrylate, trimethylene propyl triacrylate, propoxylated glycerol triacrylate, trimethylpropane ethoxy triacrylate, 1,5-hexanediol acrylate, propoxylated glycerol triacrylate, tripropylene glycol diacrylate, and ethylene glycol diacrylate.

Although the particle diameter of the organic or inorganic fine particles is not specifically limited, for example, the organic fine particles may have a particle diameter of 1 to 10 μm, and the inorganic fine particles may have a particle diameter of 1 nm to 500 nm, or 1 nm to 300 nm. The particle diameter of the organic or inorganic fine particles may be defined as a volume average particle diameter.

And, although specific examples of the organic or inorganic fine particles included in the hard coating film are not limited, for example, the organic or inorganic fine particles may be organic fine particles selected from the group consisting of acryl-based resin, styrene-based resin, epoxide resin and nylon resin, or inorganic fine particles selected from the group consisting of silicon oxide, titanium dioxide, indium oxide, tin oxide, zirconium oxide and zinc oxide.

The binder resin of the hard coating layer may further comprise high molecular weight (co)polymer having a number average molecular weight of 10,000 or more. 13,000 or more, 15,000 to 100,000, or 20,000 to 80,000. The high molecular weight (co)polymer may be one or more selected from the group consisting of cellulose-based polymer, acryl-based polymer, styrene-based polymer, epoxide-based polymer, nylon-based polymer, urethane-based polymer, and polyolefin-based polymer.

Meanwhile, another example of the hard coating layer may include a hard coating layer comprising organic polymer resin of photocurable resin; and an antistatic agent dispersed in the binder resin.

The antistatic agent may be a quaternary ammonium salt compound; a pyridinium salt; a cationic compound having 1 to 3 amino groups; an anionic compound such as sulfonic acid base, sulfuric ester base, phosphoric ester base, phosphonic acid base, and the like; an amphoteric compound such as an amino acid-based or an amino sulfuric ester-based compound, and the like; a non-ionic compound such as an imino alcohol-based compound, a glycerine-based compound, a polyethylene glycol-based compound, and the like; an organometallic compound such as a metal alkoxide compound including tin or titanium, and the like; a metal chelate compound such as an acetylacetonate salt of the organometallic compound; a reaction product or polymerization product of two or more kinds thereof; a mixture of two or more kinds thereof. Here, the quaternary ammonium salt compound may be a compound having one or more quaternary ammonium salt groups in the molecule, and low molecular type or high molecular type may be used without limitations.

And, as the anti-static agent, conductive polymer and metal oxide fine particles may be also used. As the conductive polymer, aromatic conjugated poly(paraphenylene), heterocyclic conjugated polypyrrole, polythiophene, aliphatic conjugated polyacetylene, conjugated polyaniline containing hetero atoms, mixed type conjugated poly(phenylene vinylene), double chain type conjugated compounds having multiple conjugated chains in the molecule, conductive composites wherein conjugated polymer chains are grafted or block-polymerized to saturated polymer, and the like may be mentioned. And, as the metal oxide fine particles, zinc oxide, antimony oxide, tin oxide, cerium oxide, indium tin oxide, indium oxide, aluminum oxide, antimony doped tin oxide, aluminum doped zinc oxide, and the like may be mentioned.

The hard coating layer comprising organic polymer resin of photopolymerizable resin; and an anti-static agent dispersed in the organic polymer resin may further comprise one or more compounds selected from the group consisting of alkoxy silane-based oligomer and metal alkoxide-based oligomer.

Although the alkoxy silane-based compound may be one commonly used in the art, for example, it may be one or more compounds selected form the group consisting of tetramethoxysilane, tetraethoxysilane, tetraisopropoxysilane, methyltrimethoxysilane, methyltriethoxysilane, methacryloxypropyltrimethoxysilane, glycidoxy propyl trimethoxy silane, and glycidoxy propyl triethoxy silane.

And, the metal alkoxide-based oligomer may be prepared by the sol-gel reaction of a composition comprising a metal alkoxide-based compound and water. The sol-gel reaction may be conducted by a method similar to the above explained preparation method of alkoxy silane-based oligomer. However, since the metal alkoxide-based compound may rapidly react with water, the sol-gel reaction may be conducted by diluting the metal alkoxide-based compound in an organic solvent, and then, slowly dropping water. At this time, considering the reaction efficiency, it is preferable that the mole ratio of the metal alkoxide-based compound to water (based on metal ions) is controlled within a range of 3 to 170.

Wherein, the metal alkoxide-based compound may be one or more compounds selected from the group consisting of titanium tetra-isopropoxide, zirconium isopropoxide and aluminum isopropoxide.

The light transmitting substrate included in the hard coating film according to one embodiment may be a transparent film having light transmittance of 90% or more, and haze of 1% or less.

The light transmitting substrate may have transmittance of 50% or more, at the wavelength of 300 nm or more. The light transmitting substrate may be a polymer film having low moisture permeability in which moisture permeation, i.e., the movement of moisture from a place having high vapor pressure to a place having low vapor pressure, hardly occurs through the film, and for example, the low moisture permeable polymer film may have moisture permeability of 50 g/m²·day or less, 30 g/m²·day or less, 20 g/m²·day or less or 15 g/m²·day or less, under temperature of 30 to 40° C. and relative humidity of 90 to 100%. If the moisture permeability of the light transmitting substrate is greater than 50 g/m²·day, moisture may be permeated into the anti-reflective film, and thus, deterioration of a display applying the anti-reflective film may be generated under a high temperature environment.

As explained above, the 2θ values of the first peak and the second peak may result from specific d-spacing of the polymer crystals in the light transmitting substrate, and the rate (P2/P1) of the intensity of the second peak (P2) to the intensity of the first peak (P1) may result from the size of polymer crystals in the light transmitting substrate.

And, the specific d-spacing and size of polymer crystals in the light transmitting substrate may be related to a draw ratio in the manufacturing process of a light transmitting substrate, drawing temperature, and cooling speed after drawing, and it may be also related to tensile strength rate in one direction and a direction perpendicular to the one direction of the light transmitting substrate.

Specifically, the light transmitting substrate exhibits different tensile strength values in one direction and in a direction perpendicular to the one direction, and for example, a rate of tensile strength in a direction perpendicular to one direction to tensile strength in one direction may be 2 or more, 2 to 30, 2.1 to 20, 2.2 to 10, or 2.2 to 5.

Wherein, the tensile strength in one direction is smaller than tensile strength in a direction perpendicular to the one direction. If the tensile strength rate is less than 2, reflectance deviation and light transmittance deviation according to the part of the anti-reflective film may be large, and rainbow phenomenon due to the interference of UV may be generated.

The tensile strength in one direction may be 50 to 500 Mpa, 60 to 450 Mpa, or 70 to 400 Mpa.

And, the tensile strength perpendicular to the one direction may be 50 to 500 Mpa, 60 to 450 Mpa, or 70 to 400 Mpa

The light transmitting substrate may have thickness direction retardation (Rth) measured at a wavelength of 400 nm to 800 nm, of 5,000 nm or more, 5,200 to 50,000 nm, 5,400 to 40,000 nm, 5,600 to 30,000 nm, 5,800 to 20,000 nm, or 5,800 to 10,000 nm. As specific examples of such light transmitting substrate, a uniaxially drawn polyethylene terephthalate film or a biaxially drawn polyethylene terephthalate film may be mentioned.

If the thickness direction retardation (Rth) of the light transmitting substrate is less than 5,000 nm, reflectance deviation and light transmittance deviation according to the part of the anti-reflective film may be large, and rainbow phenomenon due to the interference of UV may be generated.

The thickness direction retardation may be confirmed through commonly known measuring method and measuring apparatus. For example, as the measuring apparatus of thickness direction retardation, a product name AxoScan manufactured by AXOMETRICS Inc. may be mentioned.

For example, the thickness direction retardation (Rth) may be calculated by inputting the refractive index value (589 nm) of the light-transmitting substrate film in the measuring device, and then, measuring the thickness direction retardation of the light-transmitting substrate film using light of 590 nm wavelength under temperature of 25° C. and humidity of 40%, and converting it into a retardation value per a film thickness of 10 μm, based on the measured value of thickness direction retardation (value obtained by the automatic measurement (automatic calculation) of the measuring device). And, the size of the light-transmitting substrate is not specifically limited as long as it is larger than a sidelight part (diameter: about 1 cm) of the stage of the measuring device, but it may have a dimension of height 76 cm, width 52 mm and thickness 13 μm.

And, the value of [symbol] refractive index of the light-transmitting substrate (589 nm) [symbol] that is used for the measurement of thickness direction retardation (Rth) may be calculated by forming a non-drawn film comprising the same kind of a resin film to the light transmitting substrate that forms a film of which retardation is to be measured, and then, measuring refractive index to 589 nm light of the in-plane direction of a measuring sample (a direction vertical to the thickness direction), using the non-drawn film as a measuring sample (in case a film to be measured is a non-drawn film, the film itself may be used as a measurement sample), using a refractive measuring apparatus (product name [symbol] NAR-1T SOLID [symbol] manufactured by Atagoa Co., Ltd), using a light source of 589 nm, under temperature condition of 23° C.

And, the material of the light transmitting substrate may be triacetylcellulose, cycloolefin polymer, polyacrylate, polycarbonate, polyethylene terephalate, and the like. And, the thickness of the base film may be 10 to 300 μm considering productivity, and the like, but not limited thereto.

The anti-reflective film of one embodiment exhibits low reflectance, and thus, can realize high light transmittance and excellent optical properties. Specifically, the anti-reflective film may have an average reflectance of 2.0% or less, 1.6% or less, 1.2% or less, 0.05% to 0.9%, 0.10% to 0.70%, or 0.2% to 0.5%, in the UV wavelength region of 380 nm to 780 nm.

And, the anti-reflective film of one embodiment exhibits low reflectance deviation and light transmittance deviation, and thus, can realize excellent optical properties. Specifically, the average reflectance deviation of the anti-reflective film may be 0.2% p or less, 0.01 to 0.15% p or 0.01 to 0.1% p. And, the light transmittance deviation of the anti-reflective film may be 0.2% p or less, 0.01 to 0.15% p or 0.01 to 0.1% p.

The average reflectance deviation means a difference (absolute value) between each average reflectance in the UV wavelength region of 380 to 780 nm of two or more specific points selected in the anti-reflective film, and the mean of the average reflectances. Specifically, the average reflectance deviation may be calculated by 1) selecting two or more points in an anti-reflective film, 2) measuring each average reflectance at the two or more points, 3) calculating the arithmetic mean of the average reflectances measured in the step 2), and 4) calculating a difference (absolute value) between the average reflectance of each point and the arithmetic mean of step 3), thus finally calculating two or more average reflectance deviations. Wherein, among the two or more average reflectance deviations, the largest average reflectance deviation may be 0.2% p or less.

Meanwhile, the light transmittance deviation means a difference (absolute value) between each light transmittance of two or more specific points selected in the anti-reflective film, and the mean of the light transmittances, and the light transmittance deviation may be calculated by the same method as the method of calculating the average reflectance deviation, except that light transmittance is measured instead of average reflectance. Wherein, among the two or more light transmittance deviations, the largest light transmittance deviation may be 0.2% p or less.

According to another embodiment of the invention, a polarizing plate comprising the anti-reflective film according to the above embodiment is provided. The polarizing plate may comprise a polarizer and an anti-reflective film formed on at least one side of the polarizer.

And, according to another embodiment of the invention, there is provided a polarizing plate comprising a polarizer, a second hard coating layer having a thickness of 10 μm or less, positioned so as to oppose around the polarizer, and the anti-reflective film according to one embodiment.

The detailed explanations of the anti-reflective film and the detailed explanations and specific examples of the component included therein are as explained above.

And, the polarizing plate may be prepared using constructional components and preparation method known in the art, except that a second hard coating layer having a thickness of 10 μm or less, a polarizer and the anti-reflective film are sequentially stacked, and for example, the polarizer may include a second hard coating layer having a thickness of 10 μm or less, a polarizer, a light transmitting substrate, a hard coating layer, and a low refractive index layer sequentially stacked.

Previously known polarizing plates had structures wherein a triacetyl cellulose (TAC) film, and the like is positioned on both sides of a polarizer, but the triacetyl cellulose film has low water resistance, and thus, it may be distorted under high temperature/high humidity environment, and defects such as light leak may be induced.

However, in the polarizing plate according to another embodiment, a light transmitting substrate having the above explained properties is positioned on one side of a polarizer, and a second hard coating layer having a thickness of 10 μm or less is positioned on the other side of the polarizer, and thus, even if the polarizing plate is exposed under high temperature high humidity conditions for a long time, moisture transfer to the polarizer may be blocked, thus securing durability without significant change in the properties or shape.

And, since the polarizing plate uses a second hard coating layer having a thickness of 10 μm or less, not only moisture transfer may be blocked and durability may be secured as explained above, but also the total thickness of the polarizing plate may be decreased.

Specifically, the total thickness of the polarizer; the second hard coating layer; and the light transmitting substrate may be 200 μm or less. For example, the polarizer may have a thickness of 40 μm or less, or 1 to 40 μm, the hard coating layer may have a thickness of 10 um or less, or 1 to 10 μm, and the light transmitting substrate may have a thickness of 150 μm or less. In this case, the polarizing plate and a display comprising the polarizing plate can be made thin and light weighted

On one side of the polarizer, a second hard coating layer having a thickness of 10 μm or less may be positioned, and on the other side, the light transmitting substrate included in the anti-reflective film may be positioned. The light transmitting substrate may have thickness direction retardation (Rth) measured at a wavelength of 400 nm to 800 nm, of 5,000 nm or more, 7,000 to 50,000 nm, or 8,000 to 40,000 nm. If the thickness direction retardation (Rth) of the light transmitting substrate included in the polarizing plate is less than 5,000 nm, reflectance deviation and light transmittance deviation according to the parts of the anti-reflective film may be large, and rainbow phenomenon may be generated due to interference of visible light. Meanwhile, the measurement method and apparatus of retardation are as explained in the anti-reflective film.

And, the light transmitting substrate exhibits different tensile strengths in one direction and a direction perpendicular to one direction, and for example, a rate of tensile strength in a direction perpendicular to one direction to tensile strength in one direction may be 2 or more, 3 or more, 4 to 30, or 5 to 20. Wherein, the tensile strength in one direction is smaller than the tensile strength in a direction perpendicular to the one direction. If the tensile strength rate of the light transmitting substrate included in the polarizing plate is less than 2, reflectance deviation and light transmittance deviation according to the parts of the anti-reflective film may be large, and rainbow phenomenon may be generated due to the interference of visible light.

The second hard coating layer having a thickness of 10 μm or less may be prepared using constructional components and preparation method known in the art, and for example, it may be a film having the same construction as the hard coating layer included in the anti-reflective film.

Meanwhile, the polarizer may have a property of extracting only light vibrating in one direction from the lights entering while vibrating in many directions. Such a property may be achieved by drawing polyvinyl alcohol (PVA) absorbing iodine with strong tension. For example, the polarizer may be formed by soaking a PVA film in an aqueous solution to swell, dying with dichroic dye giving polarization property to the swollen PVA film, stretching the dyed PVA film to arrange the dichroic dye side by side in stretching direction, and correcting the color of the stretched PVA film, but not limited thereto.

The polyvinyl alcohol is not specifically limited as long as it comprises polyvinyl alcohol resin or derivatives thereof. Wherein, as the derivatives of polyvinyl alcohol, although not limited hereto, polyvinyl formal resin, polyvinyl acetal resin, and the like may be mentioned. Meanwhile, as the dichroic dyes, azo, anthraquinone, tetrazin dyes may be mentioned, but is not limited thereto. And, as the polyvinyl alcohol film, commercially available polyvinyl alcohol films commonly used in the preparation of a polarizer, for example, P30, PE30, PE60 of Kurary Co. Ltd., M3000, M6000 of Nippon Synthetic Chemical Industry Co., Ltd., and the like may be used.

Meanwhile, the polyvinyl alcohol film, although not limited hereto, may have a polymerization degree of 1000 to 10000 or 1500 to 5000. When the polymerization degree fulfills the above range, molecular movement is free, and mixing with iodine or dichromic dye, and the like may be flexibly achieved.

The polarizing plate may be used as a display, for example, the upper polarizing plate of a liquid crystal display device (LCD). And, in the stacked structure, the anti-reflective film may be positioned at the upper part, and specifically, the anti-reflective film may be positioned close to the visible side of a display device. By controlling the anti-reflective film so as to be positioned close to the visible side of a display, moisture transfer to a polarizer may be blocked to improve durability, and simultaneously, reflection of light entering from the outside may be minimized to improve the sharpness of a screen.

Meanwhile, on one side of the second hard coating layer and/or light transmitting substrate contacting the polarizer, an adhesive layer may be further included, and furthermore, between each layer or at the outermost part, other functional layers such as anti-pollution layer may be further included.

For example, the second hard coating layer and light transmitting substrate positioned on each side of the polarizer may be adhered by lamination with an adhesive. The adhesive that can be used is not specifically limited as long as it is known in the art, but for example, aqueous adhesive, mono liquid type or two liquid type polyvinyl alcohol (PVA) adhesive, polyurethane adhesive, epoxy adhesive, styrene butadiene rubber (SBR) adhesive, or hot melt adhesive, and the like may be mentioned.

According to yet another embodiment of the invention, a display apparatus comprising the above explained anti-reflective film is provided. Although specific examples of the display apparatus are not limited, for example, it may be a liquid crystal display, a plasma display apparatus, an organic light emitting diode, and the like.

For example, the display apparatus may be a liquid display apparatus comprising one pair of polarizing plates facing each other; a thin film transistor, a color filer and a liquid crystal cell sequentially stacked between the one pair of polarizing plates; and a backlight unit.

In the display apparatus, the anti-reflective film may be positioned at the side of an observer of a display panel or at the outermost surface of the backlight.

In the display apparatus comprising the anti-reflective film, an anti-reflective film may be positioned on one side of the polarizing plate relatively distant from the backlight unit, among the one pair of polarizing plates.

And, the display apparatus may comprise a display panel, a polarizer positioned on at least one side of the panel, and an anti-reflective film positioned on the opposite side.

According to the invention, there are provided an anti-reflective film that has low reflectance deviation and light transmittance deviation, can simultaneously realize high scratch resistance and anti-fouling property, and can increase screen sharpness of a display apparatus, a polarizing plate comprising the anti-reflective film, and a display apparatus comprising the anti-reflective film.

### BRIEF DESCRIPTION OF THE DRAWINGS

FIG. 1 shows the X-ray diffraction (XRD) pattern of the anti-reflective film of Example 1.

The invention will be explained in detail in the following Examples. However, these examples are presented only as the illustrations of the invention, and the scope of the invention is not limited thereby.

### PREPARATION EXAMPLE 1: PREPARATION OF A COATING SOLUTION FOR FORMING A HARD COATING LAYER

The components described in the following Table 1 were mixed to prepare coating solutions (B1, B2 and B3) for forming a hard coating layer.

TABLE 1

| (unit: g) | B1 | B2 | B3 |
|---|---|---|---|
| DPHA | | 6.237 | |
| PETA | 16.421 | 10.728 | 13.413 |
| UA-306T | 3.079 | 2.069 | 6.114 |
| 8BR-500 | 6.158 | 6.537 | 6.114 |
| IRG-184 | 1.026 | 1.023 | 1.026 |
| Tego-270 | 0.051 | 0.051 | 0.051 |
| BYK350 | 0.051 | 0.051 | 0.051 |
| 2-butanol | 25.92 | 32.80 | 36.10 |
| IPA | 45.92 | 38.80 | 35.70 |
| XX-10313Q(2.0 gm, RI 1.515) | 0.318 | 0.460 | 0.600 |
| XX-11313Q(2.0 gm, RI 1.555) | 0.708 | 0.563 | 0.300 |
| MA-ST(30% in MeOH) | 0.342 | 0.682 | 0.542 |

DPHA: dipentaerythritol hexaacrylate
PETA: pentaerythritol triacrylate
UA-306T: urethane acrylate, a reaction product of toluene diisocyanate and pentaerythritol triacrylate (a product from Kyoeisha)
8BR-500: photocurable urethane acrylate polymer (Mw 200,000, a product from Taisei Fine Chemical)
IRG-184: initiator (Irgacure 184, Ciba Company)
Tego-270: leveling agent from Tego Company
BYK350: leveling agent from BYK Company
IPA isopropyl alcohol
XX-103BQ (2.0 μm, Refractive index 1.515): copolymer particles of polystyrene and polymethyl methacrylate(product from Sekisui Plastic)
XX-113BQ (2.0 μm, Refractive index 1.555): copolymer particles of polystyrene and polymethyl methacrylate(product from Sekisui Plastic)
MA-ST (30% in MeOH): dispersion in which nanosilica particles having a size of 10~15 nm are dispersed in methyl alcohol (product from Nissan Chemical)

### PREPARATION EXAMPLE 2-1: PREPARATION OF A COATING SOLUTION (C1) FOR FORMING A LOW REFRACTIVE INDEX LAYER

100 g of trimethylolpropane triacrylate (TMPTA), 283 g of hollow silica nanoparticles (diameter range: about 42 nm to 66 nm, product from JSC catalyst and chemicals), 59 g of solid silica nanoparticles (diameter range: about 12 nm to 19 nm), 115 g of a first fluorine-containing compound (X-71-1203M, ShinEtsu), 15.5 g of a second fluorine-containing compound (RS-537, DIC) and 10 g of an initiator (Irgacure 127, Ciba Company) were diluted in a solvent of MIBK (methyl isobutyl ketone) such that solid content concentration became 3 wt %, thus preparing a coating solution for forming a low refractive index layer (a photocurable coating composition).

### PREPARATION EXAMPLE 2-2: PREPARATION OF A COATING SOLUTION (C2) FOR FORMING A LOW REFRACTIVE INDEX LAYER

100 g of dipentaerythritol hexaacrylate (DPHA), 143 g of hollow silica nanoparticles (diameter range: about 51 nm to 72 nm, product from JSC catalyst and chemicals), 29 g of solid silica nanoparticles (diameter range: about 12 nm to 19 nm), 56 g of a fluorine-containing compound (RS-537, DIC) and 3.1 g of an initiator (Irgacure 127, Ciba Company) were diluted in a solvent of MIBK (methyl isobutyl ketone) such that solid content concentration became 3.5 wt %, thus preparing a coating solution for forming a low refractive index layer (a photocurable coating composition).

### EXAMPLES 1 TO 4 AND COMPARATIVE EXAMPLES 1 TO 4: PREPARATION OF ANTI-REFLECTIVE FILMS

On each light transmitting substrate (thickness 80 μm) described in the following Table 2, each coating solution (B1, B2, B3) for forming a hard coating layer prepared above was coated with #12 mayer bar, and then, dried at 60° C. for 2 minutes, and UV cured to form a hard coating layer (coating thickness 5 μm). As an UV lamp, H bulb was used, and a curing reaction was progressed under nitrogen atmosphere. The quantity of UV irradiated during curing was 100 mJ/cm².

On the hard coating layer, each coating solution (C1, C2) for forming a low refractive index layer was coated with #4 mayer bar to a thickness of about 110 to 120 nm, and dried at 40° C. for 1 minute and cured. During curing, UV was irradiated at 252 mJ/cm² to the dried coating solution under nitrogen purging.

TABLE 2

| | | Anti-reflective film | | |
|---|---|---|---|---|
| | | Light transmitting | | |
| | Tensile | substrate | Hard | Low |
| | strength | Thickness direction | coating | refractive |
| | rate* | retardation (Rth, nm) | layer | index layer |
| Example 1 | 4.1 | 9300 | Coating | Coating |
| | | | solution | solution |
| | | | (B1) | (C1) |
| Example 2 | 4.0 | 9200 | Coating | Coating |
| | | | solution | solution |
| | | | (B2) | (C1) |
| Example 3 | 2.9 | 9230 | Coating | Coating |
| | | | solution | solution |
| | | | (B2) | (C1) |
| Example 4 | 3.7 | 9300 | Coating | Coating |
| | | | solution | solution |
| | | | (B3) | (C1) |
| Example 5 | 2.2 | 5800 | Coating | Coating |
| | | | solution | solution |
| | | | (B1) | (C2) |
| Comparative | 1.8 | 3500 | Coating | Coating |
| Example 1 | | | solution | solution |
| | | | (B3) | (C1) |
| Comparative | 1.6 | 3000 | Coating | Coating |
| Example 2 | | | solution | solution |
| | | | (B2) | (C1) |
| Comparative | 1.3 | 3200 | Coating | Coating |
| Example 3 | | | solution | solution |
| | | | (B2) | (C1) |
| Comparative | 1.8 | 1500 | Coating | Coating |
| Example 4 | | | solution | solution |
| | | | (B1) | (C2) |

*tensile strength rate: a rate of tensile strength in a direction perpendicular to one direction, having large value, to tensile strength in one direction, having smaller value, in the light transmitting substrate, The tensile strength of the light transmitting substrate is measured according to JIS C-2318.

Evaluation

1. Evaluation of X-Ray Diffraction (XRD) of Reflection Mode

For the anti-reflective films obtained in Examples and Comparative Examples, 2 cm*2 cm (width*length) samples were prepared, and then, Cu-Kα rays of 1.54 Å wavelength were irradiated to measure X-ray diffraction (XRD) pattern of reflection mode.

Specifically, on a low background silicon holder (Bruker CorporationE), the sample was fixed without being lifted, and as the measuring apparatus, Bruker AXS D4 Endeavor XRD was used. The voltage and current used were respectively 40 kV and 40 mA, and the optics and detector used were as follows.
Primary (incident beam) optics: motorized divergence slit, soller slit 2.3°
Secondary (diffracted beam) optics: soller slit 2.3°
LynxEye detector (1D detector)

The measurement mode was a coupled 2θ/θ mode, and a region having 2θ of 6° to 70° was measured using FDS (Fixed Divergence Slit) 0.3°, every 0.04° for 175 seconds.

Thereafter, a peak appearing at 2θ value of 25 to 27° is designated as a first peak, a peak appearing at 2θ value of 46 to 48° is designated as a second peak, and the 2θ values were respectively described in the following Table 3. And, a rate (P2/P1) of the strength of the second peak (P2) to the strength of the first peak (P1) was calculated, and the result was described in the following Table 3.

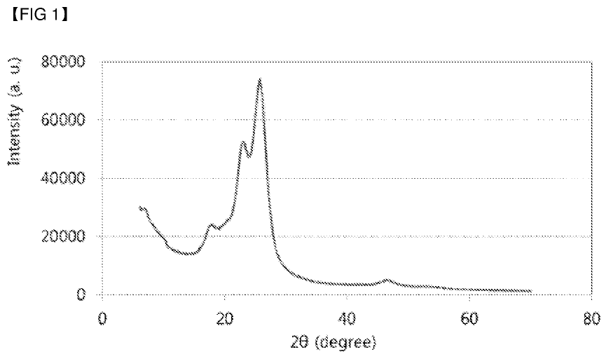

Meanwhile, FIG. 1 shows a X-ray diffraction (XRD) pattern of the anti-reflective film of Example 1.

2. Evaluation of Average Reflectance

The rear side (one side of the light transmitting substrate on which a hard coating layer is not formed) of each anti-reflective film obtained in Examples and Comparative Examples was darkened, and then, average reflectance in the wavelength region of 380 nm to 780 nm was measured using a reflectance mode of Solidspec 3700 (SHIMADZU), and the results were shown in the following Table 3.

3. Evaluation of Average Reflectance Deviation

For each anti-reflective film obtained in Examples and Comparative Examples, 20 points were randomly selected, and for each point, average reflectance was measured by the method of 2. Evaluation of Average Reflectance. Thereafter, the arithmetic mean of the measured average reflectances of 20 points was calculated. Thereafter, a difference (absolute value) between the average reflectance at each point and the arithmetic mean was defined as average reflectance deviation, and each average reflectance deviation was calculated at each of 20 points. Among the 20 average reflectance deviations, the largest average reflectance deviation was described in the following Table 3.

4. Evaluation of Light Transmittance Deviation

For each anti-reflective film obtained in Examples and Comparative Examples, 20 points were randomly selected, and for each point, light transmittance was measured.

Specifically, average light transmittance in the wavelength region of 380 to 780 nm was measured using a transmittance mode of Solidspec 3700 (SHIMADZU).

Thereafter, the arithmetic mean of the measured light transmittances of 20 points was calculated. Thereafter, a difference (absolute value) between the light transmittance at each point and the arithmetic mean was defined as light transmittance deviation, and each light transmittance deviation was calculated at each of 20 points. Among the 20 light transmittance deviations, the largest light transmittance deviation was described in the following Table 3.

5. Evaluation of Moisture Permeability

The moisture permeability of each anti-reflective film obtained in Examples and Comparative Examples was measured at a temperature of 38° C. and relative humidity of 100%, using MOCON test apparatus (PERMATRAN-W, MODEL 3/61).

TABLE 3

| | | | | | Average | Light | Moisture |
|---|---|---|---|---|---|---|---|
| | First | Second | Peak | Average | reflectance | transmittance | permeability |
| | peak | peak | intensity | reflectance | deviation | deviation | (g/m² · |
| | (°) | (°) | rate* | (%) | (% p) | (% p) | day) |
| Example 1 | 25.6 | 46.6 | 0.058 | 1.13 | 0.04 | 0.01 | 11.13 |
| Example 2 | 25.7 | 46.6 | 0.055 | 1.27 | 0.11 | 0.08 | 10.28 |
| Example 3 | 25.8 | 46.5 | 0.068 | 1.11 | 0.07 | 0.03 | 12.31 |
| Example 4 | 25.8 | 46.7 | 0.059 | 1.03 | 0.16 | 0.04 | 11.51 |
| Example 5 | 25.7 | 46.8 | 0.034 | 1.58 | 0.05 | 0.07 | 10.95 |
| Comparative | 25.4 | 46.5 | 0.0055 | 1.15 | 0.31 | 0.29 | 11.33 |
| Example 1 | | | | | | | |
| Comparative | 25.6 | 46.6 | 0.0051 | 1.22 | 0.25 | 0.28 | 10.82 |
| Example 2 | | | | | | | |
| Comparative | 25.5 | 46.6 | 0.0054 | 1.0 | 0.28 | 0.3 | 11.18 |
| Example 3 | | | | | | | |
| Comparative | 25.7 | 46.5 | 0.0055 | 1.54 | 0.3 | 0.31 | 12.36 |
| Example 4 | | | | | | | |

*Peak strength rate: a rate (P2/P1) of the strength of a second peak(P2) to the strength of a first peak(P1)

According to the Table 3, the anti-reflective films of Examples 1 to 5 exhibited average reflectance deviation of 0.16% p or less, and light transmittance deviation of 0.08% p, and thus, it was confirmed that there was little difference in the average reflectance and light transmittance across the anti-reflective film. However, it was confirmed that the anti-reflective films of Comparative Examples 1 to 4 had remarkably high average reflectance deviations and light transmittance deviations, unlike the anti-reflective films of Examples 1 to 5.

### PREPARATION EXAMPLE 3: PREPARATION OF A POLARIZER INCLUDING A SECOND HARD COATING LAYER FORMED ON ONE SIDE

(1) Preparation of a Coating Solution (A) for Forming a Second Hard Coating Layer

28 g of trimethylolpropane triacrylate, 2 g of KBE-403, 0.1 g of initiator KIP-100f, and 0.06 g of a leveling agent (Tego wet 270) were uniformly mixed to prepare a coating solution (A) for forming a second hard coating layer.

(2) Preparation of a Polarizer Including a Second Hard Coating Layer Formed on One Side

On one side of a polyvinyl alcohol polarizer (thickness 25 um, Manufacturing Company: LG Chem.), the coating solution (A) for forming a second hard coating layer was applied to a thickness of 7 um, and UV of 500 mJ/cm² was irradiated to the dried coating under nitrogen purging, thus preparing a polarizer including a second hard coating layer formed on one side.

### EXAMPLES 6 TO 10 AND COMPARATIVE EXAMPLES 5 TO 8: PREPARATION OF POLARIZING PLATE

As described in the following Table 4, on the light transmitting substrate of the anti-reflective film respectively obtained in Examples 1 to 5 and Comparative Examples 1 to 4, the polarizer including a second hard coating layer formed on one side, obtained in the Preparation Example 3, was adhered with UV adhesive to prepare a polarizing plate. Specifically, the polarizing plate was prepared such that the light transmitting substrate of the anti-reflective film and the polarizer are in direct contact, and the prepared polarizing plate included a low refractive index layer, a hard coating layer, a light transmitting substrate, a polarizer, and a second hard coating layer sequentially stacked.

TABLE 4

| | Anti-reflective | Polarizer having a second hard |
|---|---|---|
| | film | coating layer formed on one side |
| Example 6 | Example 1 | Preparation Example 3 |
| Example 7 | Example 2 | Preparation Example 3 |
| Example 8 | Example 3 | Preparation Example 3 |
| Example 9 | Example 4 | Preparation Example 3 |
| Example 10 | Example 5 | Preparation Example 3 |
| Comparative | Comparative | Preparation Example 3 |
| Example 5 | Example 1 | |
| Comparative | Comparative | Preparation Example 3 |
| Example 6 | Example 2 | |
| Comparative | Comparative | Preparation Example 3 |
| Example 7 | Example 3 | |
| Comparative | Comparative | Preparation Example 3 |
| Example 8 | Example 4 | |

Evaluation

1. Evaluation of Average Reflectance Deviation and Light Transmittance Deviation

For the Examples 6 to 10 and Comparative Examples 5 to 8, average reflectance deviation and light transmittance deviation were measured by the method as explained above, and the results were shown in the following Table 5.

2. Crack Property

Each polarizing plate of Examples 6 to 10 and Comparative Examples 5 to 8 was cut into a square having one side length of 10 cm, and joined to one side of glass for TV (width 12 cm, height, 12 cm, thickness 0.7 mm) to prepare a sample for evaluating thermal shock. Wherein, the polarizing plate was cut such that the MD direction of the polarizer is parallel to one side of square. The cut sample stood vertically in a thermal shock chamber, and the temperature was raised from a room temperature to 80° C. and left for 30 minutes, the temperature was lowered to −30° C. and left for 30 minutes, and then, the temperature was controlled to a room temperature, which was set as 1 cycle and repeated total 100 cycles. Thereafter, it was confirmed with naked eyes that cracks were generated between the polarizer of the sample and gaps were generated between the polarizer, the number of cracks having length of 1 cm or more was confirmed, and the results were described in the following Table 5.

TABLE 5

| | Average reflectance | Light transmittance | |
|---|---|---|---|
| | deviation (% p) | deviation (% p) | crack |
| Example 6 | 0.05 | 0.03 | 0 |
| Example 7 | 0.12 | 0.05 | 0 |
| Example 8 | 0.05 | 0.04 | 0 |
| Example 9 | 0.13 | 0.06 | 0 |
| Example 10 | 0.04 | 0.05 | 0 |
| Comparative | 0.27 | 0.3 | 3 |
| Example 5 | | | |
| Comparative | 0.30 | 0.29 | 2 |
| Example 6 | | | |
| Comparative | 0.29 | 0.35 | 4 |
| Example 7 | | | |
| Comparative | 0.35 | 0.33 | 3 |
| Example 8 | | | |

According to Table 5, it was confirmed that the polarizing plates of Examples 6 to 10 have average reflectance deviations of 0.13% p or less, and light transmittance deviation of 0.06% p or less, and thus, there is little difference in the average reflectance and light transmittance across the polarizing plate, and there is no visibility deviation according to the region. However, the polarizing plates of Comparative Examples 5 to 8, unlike the polarizing plates of Examples 6 to 8, have remarkably high average reflectance deviations and light transmittance deviations, and thus, it can be expected that visibility deviation may significantly appear according to the region.

And, it was confirmed that in Examples 6 to 10 having low average reflectance and light transmittance deviations, cracks are not generated at all in 100 cycle repeated crack test. To the contrary, in the polarizing plates of Comparative Examples 5 to 8, cracks are generated.

1. An anti-reflective film comprising
a light transmitting substrate; a hard coating layer; and a low refractive index layer,
wherein a first peak appears at 2θ value of 25 to 27°, and a second peak appears at 2θ value of 46 to 48°, in X-ray diffraction (XRD) pattern of reflection mode, and
a rate (P2/P1) of the intensity of the second peak (P2) to the intensity of the first peak (P1) is at least 0.01.

2. The anti-reflective film according to claim 1, wherein the light transmitting substrate has a moisture permeability under temperature of 30 to 40° C. and relative humidity of 90 to 100%, of 50 g/m²·day or less.

3. The anti-reflective film according to claim 1, wherein the low refractive index layer comprises a binder resin and inorganic fine particles dispersed in the binder resin.

4. The anti-reflective film according to claim 3, wherein the binder resin comprises a crosslinked polymer between photopolymerizable compounds and fluorine-containing compounds including photoreactive functional groups.

5. The anti-reflective film according to claim 3, wherein the inorganic fine particles include one or more selected from the group consisting of solid inorganic nanoparticles having a diameter of 0.5 to 100 m, and hollow inorganic nanoparticles having a diameter of 1 to 200 nm.

6. The anti-reflective film according to claim 1, wherein the hard coating layer comprises a binder resin comprising photocurable resin, and organic or inorganic fine particles dispersed in the binder resin.

7. The anti-reflective film according to claim 6, wherein the binder resin of the hard coating layer further comprises a high molecular weight (co)polymer having a number average molecular weight of at least 10,000.

8. The anti-reflective film according to claim 1, wherein the light transmitting substrate has thickness direction retardation (Rth) measured at a wavelength of 400 nm to 800 nm, of at least 5,000 nm,
a rate of a tensile strength in a direction perpendicular to one direction to a tensile strength in the one direction, of at least 2, and
the tensile strength in one direction is smaller than the tensile strength in a direction perpendicular to the one direction.

9. The anti-reflective film according to claim 1, wherein a light transmitting substrate is a polyethylene terephthalate film.

10. The anti-reflective film according to claim 1, wherein the anti-reflective film has average reflectance in the wavelength region of 380 nm to 780 nm, of 2.0% or less.

11. The anti-reflective film according to claim 1, wherein the anti-reflective film has an average reflectance deviation of 0.2% p or less, and a light transmittance deviation of 0.2% p or less.

12. A polarizing plate comprising the anti-reflective film according to claim 1, and a polarizer.

13. A polarizing plate comprising
a polarizer; a second hard coating layer with a thickness of 10 μM or less; and the anti-reflective film according to claim 1,
wherein the second hard coating layer and the anti-reflective film are positioned so as to face based on the polarizer.

14. The polarizing plate according to claim 13, wherein a total thickness of the polarizer; the second hard coating layer; and the anti-reflective film is 200 μM or less.

15. The polarizing plate according to claim 13, wherein the second hard coating layer with a thickness of 10 μM or less is positioned on one side of the polarizer, and the light transmitting substrate of the antireflective film is positioned on the other side,
wherein the light transmitting substrate has thickness direction retardation (Rth) measured at a wavelength of 400 nm to 800 nm, of at least 5,000 nm,
wherein the light transmitting substrate has a rate of a tensile strength in a direction perpendicular to one direction to a tensile strength in the one direction, of at least 2, and
wherein the tensile strength in one direction is smaller than the tensile strength in a direction perpendicular to the one direction.

16. A display apparatus comprising the anti-reflective film according to claim 1.
